(19) United States
(12) Patent Application Publication
(10) Pub. No.: US 2015/0247683 A1
(43) Pub. Date: Sep. 3, 2015

(54) PLATE HEAT EXCHANGER HAVING AN IN PARTICULAR T-SHAPED CONNECTING ELEMENT

(71) Applicant: LINDE AKTIENGESELLSCHAFT, München (DE)

(72) Inventors: Bernhard Stöckl, Tacherting (DE); Andrea Pilzweger, Burghausen (DE)

(21) Appl. No.: 14/429,063

(22) PCT Filed: Sep. 18, 2013
(86) PCT No.: PCT/EP2013/002808

§ 371 Date: Mar. 18, 2015

(30) Foreign Application Priority Data
Sep. 18, 2012 (EP) 12006546.1

(51) Int. Cl. F28F 3/08; B23P 15/26

(52) U.S. Cl. CPC F28F 3/08; B23P 15/26

(57) ABSTRACT

A plate heat exchanger, comprising: a first and a second plate heat exchanger module, which are connected to one another by way of a connecting means. The two plate heat exchanger modules each have a first outer side that face each other or bear against one another, and each have a second outer side starting from the first outer side. The connecting means has at least one first connecting element fastened to the second outer side of the first plate heat exchanger module, and a second connecting element fastened to the second outer side of the second plate heat exchanger module wherein the first connecting element is configured to engage behind the second connecting element.

The invention relates to a plate heat exchanger according to the preamble of claim 1 and to a method for retrofitting or repairing a plate heat exchanger according to the preamble of claim 15.

A plate heat exchanger of this type has at least one first and one second plate heat exchanger module for conducting process flows, wherein said modules are connected to each other via a connecting means, wherein the two plate heat exchanger modules each have a first outer side extending in particular along the vertical, wherein said two outer sides face each other and in particular bear against each other, i.e. optionally form contact surfaces of the two plate heat exchanger modules. Furthermore, the two plate heat exchanger modules each have a second outer side branching off from the first outer side (in particular extending along the vertical), wherein the two second outer sides in particular lie in a common plane of extension.

EP 1 452 817 A1 discloses a plate heat exchanger which comprises two heat exchanger blocks (modules). The heat exchanger blocks are connected to each other in a manner spaced apart at the mutually facing outer sides thereof via a plate or a strip.

During the operation, in particular at the entry and exit of a process plant of this type, said plate heat exchanger modules can be exposed to different temperatures or can have different temperatures. Since welds are customarily used for connecting such plate heat exchanger modules via said first outer sides, said temperature differences, in particular in the region of the module connecting scams (weld seams), can induce impermissibly high material stresses which can lead to destruction of the connection or of the plate heat exchanger modules adjacent to one another.

Taking this as the starting point, the present invention is therefore based on the problem of providing a (modular) plate heat exchanger of the type mentioned at the beginning that is improved in respect of the aforementioned disadvantages. In addition, a method for retrofitting or repairing plate heat exchangers which already exist and in particular have already been commissioned is provided in order to improve plate heat exchangers in respect of the aforementioned disadvantages.

This problem is solved by a module arrangement with the features of claim 1 and a method according to claim 15.

According thereto, a plate heat exchanger is provided, comprising: a first and a second plate heat exchanger module, which are connected to each other via a connecting means, wherein the two plate heat exchanger modules each have a first outer side, wherein the two outer sides face each other, in particular bear against each other, and wherein the two plate heat exchanger modules each have a second outer side branching off from the first outer side.

According to the invention, it is provided that the connecting means has at least one first connecting element fastened to the second outer side of the first plate heat exchanger module and a second connecting element fastened to the second outer side of the second plate heat exchanger module, wherein the first connecting element is designed to engage behind the second connecting element, and therefore the two plate heat exchanger modules are fixed on each other normally to the first outer sides (in particular because of the position of the first connecting element with respect to the second connecting element and the shape of the connecting elements), and a lateral compensating movement between the plate heat exchanger modules is possible in order to compensate for thermal stresses. This means that lateral compensating movement for relaxing possible temperature stresses are not obstructed.

Within the scope of the present invention, a method for retrofitting or repairing a plate heat exchanger is also provided, which method has a first and a second plate heat exchanger module, wherein the two plate heat exchanger modules each have a first outer side, wherein the two outer sides face each other, in particular bear against each other, and wherein the two plate heat exchanger modules each have a second outer side branching off from the first outer side. According to the invention, a first connecting element of a connecting means is fitted on the second outer side of the first plate heat exchanger module and a second connecting element of the connecting means is fitted on the second outer side of the second plate heat exchanger module, wherein the first connecting element engages behind the second connecting element, and therefore the two plate heat exchanger modules are fixed on each other normally to the first outer surfaces thereof, and a lateral compensating movement between the plate heat exchanger modules is possible in order to compensate for thermal stresses. This method is preferably used for plate heat exchangers in which the connection, generally a weld via metallic edge strips, between the modules is weakened and partially or entirely destroyed by an operation which has already taken place. With the method according to the invention, a secure and permanent connection can be provided between the modules.

Said plate heat exchanger modules preferably consist of a multiplicity of wavy structures (what are referred to as “fins”) which are arranged in a stacked manner one above another and are separated from one another by plates (separating plates). A multiplicity of parallel heat exchange passages are thereby formed, and therefore two process media which are conducted into adjacent heat exchange passages and flow through the channels of the respective heat exchange passage, which channels are delimited by the respective fin and the adjacent plates, can enter into indirect heat exchange with each other. The individual heat exchange passages (fins) are closed off toward the outside by “side bars”. The two outermost plates of such a plate heat exchanger module, which plates outwardly delimit the two outermost heat exchange passages of the plate heat exchanger module, are referred to as cover plates.

Plate heat exchangers of this type are preferably brazed from aluminum. The individual heat exchange passages with the fins, plates, side bars and cover plates and optionally further components which serve, for example, for distributing the process media to the individual passages (for example distributor fins) or permit the respective process medium to converge after passing through the associated heat exchange passage(s) are stacked on one another, are provided with brazing metal and brazed in a furnace. Headers and connecting pieces, via which the individual heat exchange passages can be loaded with the process media or via which process media can be collected from the plate heat exchanger module and removed, are then welded onto the resulting block.

By means of the aforementioned production method, the maximum size of such a plate heat exchanger block or module is also predetermined by the size and geometry of the brazing furnace used. If the process requirements require larger heat exchange surfaces and therefore larger heat exchanger blocks, two or more plate heat exchanger modules of the aforementioned type can be connected to each other. Within the context of this application, a plate heat exchanger module is therefore understood in particular also as meaning a heat exchanger block which is produced in a brazing furnace of the type described above.

In one embodiment of the invention, it is provided that the first connecting element has a first limb which, along a first direction of extension which is preferably oriented perpendicularly to the first outer side of the first plate heat exchanger module, protrudes beyond the first outer side of the first plate heat exchanger module such that the first limb comes to lie partially in front of the second outer side of the second plate heat exchanger module and preferably bears against said outer side. The second connecting element preferably protrudes analogously beyond the first outer side of the second plate heat exchanger module and comes to lie on the second outer side of the first plate heat exchanger module or bears against said outer side. By means of this alternating overlapping, the two plate heat exchanger modules can basically also be locked to each other normally to the second outer sides.

Furthermore, it is preferably provided that the first connecting element has a second limb which comes to lie in front of the second outer side of the second plate heat exchanger module and in particular bears against said outer side and which branches off from the first limb along a second direction of extension oriented transversely with respect to the first direction of extension and, with a free end region, engages behind the second connecting element, and therefore the two plate heat exchanger modules can move relative to each other along the second direction of extension, for example for compensating for thermal stresses, but are fixed to each other along a normal to the first outer sides (i.e. along the first direction of extension). The connecting means thus prevent the two first outer sides from expanding in the region of the connecting means.

It is furthermore preferably provided that the first connecting element has a third limb which branches off from the first limb in the opposite direction to the second limb and comes to lie in the front of the second outer side of the second plate heat exchanger module and in particular bears against said outer side, wherein the third limb with a free end region engages behind a third connecting element of the connecting means, wherein said third connecting element is fastened to the second outer side of the second plate heat exchanger module, specifically preferably analogously to the second connecting means.

The first connecting element is preferably of T-shaped design, i.e. the second limb and the third limb are aligned with each other along the second direction of extension, and therefore the three limbs are arranged in said T-shaped configuration with respect to one another.

Furthermore, it is preferably provided that the first limb is arranged between the second and the third connecting element along the second direction of extension, wherein the first limb is in each case spaced apart from the second and the third connecting element along the second direction of extension, and therefore the second and the third connecting element each define a stop for the first limb of the first connecting element, said stops limiting a movement of the two plate heat exchanger modules relative to each other along the second direction of extension. In other words, the first limb of the first connecting element is therefore arranged with play between the two other connecting elements, and therefore a movement of the two plate heat exchanger modules relative to each other along the second direction of extension is possible within a certain scope and is not prevented by the second or third connecting element.

In an alternative embodiment of the invention, it is provided that the first connecting element has a third limb which branches off from an end region of the second limb such that the first connecting element is in particular of U-shaped design and preferably engages around the second connecting element (the third connecting element is not present here). It is preferably provided here for said third limb to run parallel to the first limb. Said third limb preferably protrudes beyond the first outer side of the first plate heat exchanger module along the first direction of extension such that the third limb comes to lie partially in front of the second outer side of the second plate heat exchanger module and in particular bears against said outer side. The first connecting element is preferably fastened to the second outer side of the first plate heat exchanger module via an end region of the first limb and via an end region of the third limb, in particular via a weld.

So that a certain relative movement of the two plate heat exchanger modules with respect to each other is possible along the second direction of extension, the second connecting element is arranged between the first and the third limb of the first connecting element along the second direction of extension, wherein the second connecting element is arranged spaced apart from the first and the third limb along the second direction of extension such that the first and the third limb each define a stop for the second connecting element, wherein said stops limit a movement of the two plate heat exchanger modules relative to each other along the second direction of extension.

In a further alternative embodiment, it is provided that the first connecting element is of L-shaped design (i.e. merely has the first and the second limb), wherein in particular the first connecting element is fastened to the second outer side of the first plate heat exchanger module via an end region of the first limb of the first connecting element. It is furthermore preferably provided that the second connecting element has a first limb which protrudes beyond the first outer side of the second plate heat exchanger module counter to the first direction of extension such that the first limb of the second connecting element comes to lie partially in front of the second outer side of the first plate heat exchanger module and in particular bears against said outer side, wherein preferably the second connecting element is fastened to the second outer side of the second plate heat exchanger module via an end region of the first limb of the second connecting element, specifically preferably by means of a weld. The second connecting element preferably has the same shape as the first connecting element, i.e. is likewise preferably of L-shaped design, and therefore the two connecting elements can engage behind each other. In this case, for engaging behind the first connecting element, the second connecting element likewise has a second limb which branches off from the first limb and preferably comes to lie in front of the second outer side of the first plate heat exchanger module and in particular bears against said outer side. Said second limb of the second connecting element preferably branches off here from the first limb of the second connecting element along the second direction of extension and extends behind the first connecting element, namely preferably behind that end region of the first limb of the first connecting element via which the first connecting element is fastened to the second outer side of the first plate heat exchanger module, and therefore in particular the two plate heat exchanger modules can move relative to each other along the second direction of extension and are fixed to each other normally to the first outer sides. The first limb of the first connecting element is preferably arranged spaced apart from the first limb of the second connecting element along the second direction of extension, and therefore the two plate heat exchanger modules can move relative to each other (to a limited extent) along the second direction of extension.

In the individual embodiments, said connecting elements are preferably manufactured from a metal, in particular from aluminum or steel.

In the individual embodiments, the first connecting element is preferably fastened to the second outer side of the first plate heat exchanger module via a weld, specifically preferably via an end region of the first limb and optionally via an end region of a possible third limb.

The second and the third connecting element are preferably also connected to the second outer side of the second plate heat exchanger module in each case via an end region (of a first limb) by means of a weld.

Furthermore, in the individual embodiments, the limbs of a connecting element are preferably connected to each other in one piece or are integrally formed on each other in one piece.

Particularly preferably, the first outer sides of the first and second plate heat exchanger modules each form a surface of an (outermost) cover plate of the first and second plate heat exchanger modules.

Furthermore, the two plate heat exchanger modules are preferably connected to each other via a common header via which the two plate heat exchanger modules can be charged with at least one process medium. Said connecting means then serves in particular to prevent an expansion of the connection between the two first outer sides, that might occur, for example, if cold media flow through the header and therefore shrinkage of the header occurs, pulling the two first outer sides apart, in particular on a side opposite the header. Furthermore, however, said connection also serves for the general stability (avoidance of the expansion) of the modular plate heat exchanger for support during operation or else even for handling in the factory or during transport where the connection via just one or a few common headers at one end of the plate heat exchanger modules would not suffice.

The above connecting means is preferably also arranged or provided in the same manner on two third outer sides (extending in a plane) of said plate heat exchanger modules, which outer sides run parallel to the two second outer sides.

Since the individual connecting means always protrude from the respectively associated plate heat exchanger module to which they are fastened, the plate heat exchanger modules overlap in an alternating manner with said connecting means (interlacing). Locking of the plate heat exchanger modules to each other in a third direction of extension orthogonal to the first and second direction of extension (Z direction) is therefore likewise ensured.

The connecting means according to the invention is furthermore not restricted to plate heat exchanger modules, but can advantageously also be used in other process apparatuses (modules) which can be exposed in particular to significant temperature differences.

Further details and advantages of the invention will be explained by the description below of the figures of an exemplary embodiment with reference to the figures, in which

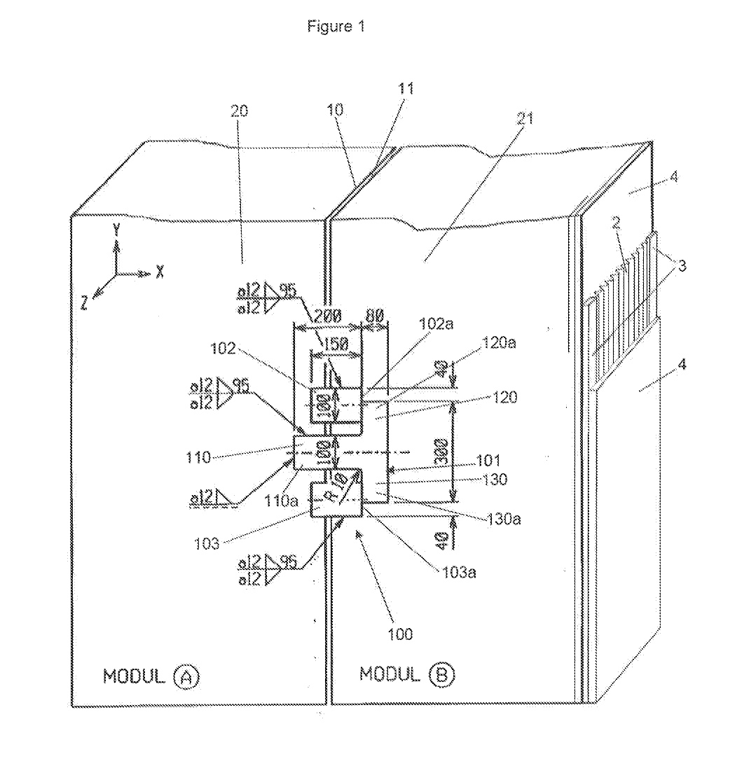

FIG. 1 shows a schematic view of a plate heat exchanger according to the invention, with two plate heat exchanger modules which are connected to each other via a connecting means which serves in particular for preventing expansion of the contact surface formed between the two plate heat exchanger modules, wherein the second plate heat exchanger module is illustrated partially torn open in order to indicate the position of the plates, fins, side bars and cover plates of the plate heat exchanger modules;

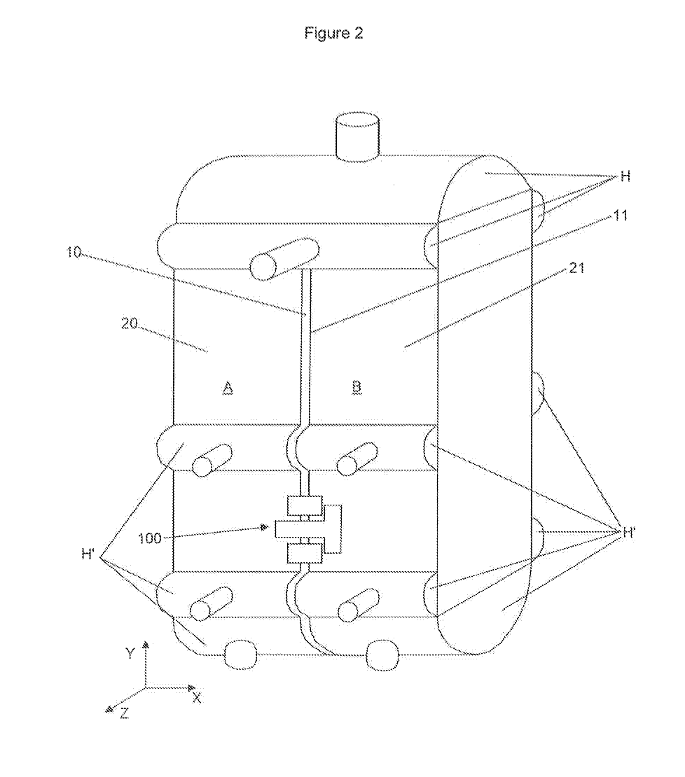

FIG. 2 shows a schematic view of two plate heat exchanger modules with common headers and a connecting means according to the type of FIG. 1; and

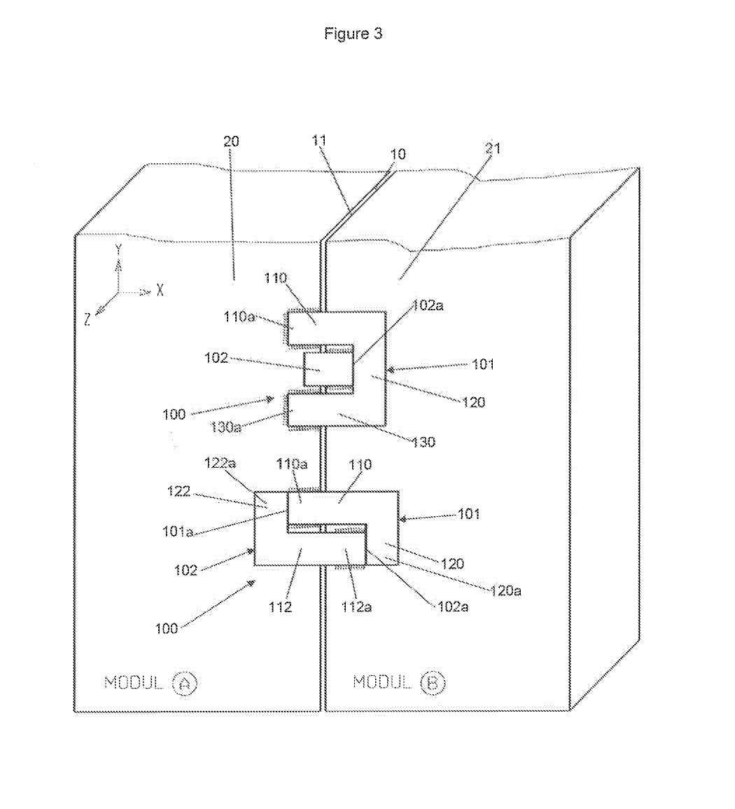

FIG. 3 shows two alternative connecting means.

FIG. 1 shows a schematic perspective view of a plate heat exchanger according to the invention with a first plate heat exchanger module A and a second plate heat exchanger module B.

A plate heat exchanger module A, B of this type has a plurality of fins 2 which each extend along the Z-Y plane and are each arranged between two plates 4 of the plate heat exchanger module A, B, said plates extending along said plane. The fins 2 are delimited toward the sides by side bars 3 which are brazed to the respectively adjacent plates 4. By this means, the respective plate heat exchanger A, B has a multiplicity of parallel heat exchange passages in which process media can flow and can indirectly transmit heat to process media conducted in adjacent heat exchange passages. The individual heat exchange passages can be charged with process media via headers H, H′ (cf. FIG. 2). The respectively outermost plates 4 of a plate heat exchanger module A, B are also referred to as cover plates, wherein, in the present case, the two first outer sides 10, 11 are formed by such a cover plate of the first and second plate heat exchanger module A, B. The two cover plates or first outer sides 10, 11 preferably bear against each other, i.e. in each case form a contact surface with the adjacent plate heat exchanger module A or B. However, it is also possible that the two plate heat exchanger modules A, B can have a small spacing normally to the two first outer sides 10, 11 thereof extending in each case along the Z-Y plane. A second outer side 20, 21 branches off in each case from the respective first outer side 10, 11 perpendicularly to the two first outer sides 10, 11, wherein said second outer sides 20, 21 in each case extend along the Y-X plane and have a common plane of extension here. The first and second outer sides 10, 11, 20, 21 preferably extend along the vertical Y with respect to a correctly arranged state of the two plate heat exchanger modules A, B.

Customarily, in order to connect two such plate heat exchanger modules A, B, use is made of weld seams which connect the first outer sides 10, 11 to each other. However, this has the disadvantage that considerable stresses can be induced in such connections if the two plate heat exchanger modules A, B have different temperatures. In order to present destruction of such connections from the outset, an alternative connecting means 100 is proposed according to the invention.

In a first embodiment according to FIG. 1, said connecting means 100 has a first connecting element 101 which is of T-shaped design two-dimensionally, with a first limb 110 which extends along a first direction of extension X which runs normally to the two first outer sides 10, wherein said first limb 110 rests with an end region 110 on the second outer side 10 of the first plate heat exchanger module A and is welded here to the second outer side 20 such that the remaining part of the first connecting element 101 protrudes beyond the first outer side 10 of the first plate heat exchanger module A along the first direction of extension X and is arranged here in front of the second outer side 21 of the second plate heat exchanger module B or is opposite said second side 21.

On a further end region opposite said end region 110a, the first limb 110 now has a second and a third limb 120, 130 which branch off in opposite directions from said further end region of the first limb 110 such that they are aligned with each other along a second direction of extension Y, which runs perpendicularly to the first direction of extension X and is oriented here parallel to the two second outer sides 20, 21, and therefore the first connecting element 101 obtains said T-shaped design. The second direction of extension Y runs along the vertical with respect to a correctly arranged state of the plate heat exchanger modules A, B.

Furthermore, along the second direction of extension Y or along the vertical, a second rectangular connecting element 102 is provided above the first limb 110 of the first connecting element 101 and a third rectangular connecting element 103 is provided below the first limb 110, wherein the two further connecting elements 102, 103, which are arranged spaced apart from the first limb 110 along the second direction of extension Y, rest on the second outer side 21 of the second plate heat exchanger module B and are connected to said outer side via a respective weld. The second and the third connecting elements 102, 103 here protrude with a respective free end region beyond the first outer side 11 of the second plate heat exchanger module B counter to the first direction of extension X such that said free end regions come to lie in front of the second outer side 20 of the first plate heat exchanger module A.

The second and the third connecting element 102, 103 are now arranged with respect to the first connecting element 101 in such a manner that the latter, with the second limb 120 thereof, engages behind the second connecting element 102 and, with the third limb 130 thereof, engages behind the third connecting element 103. That is to say, the second and the third limb 120, 130 of the first connecting element 101 each bear against a bearing surface 102a, 103a of the second and third connecting elements 102, 103, which bearing surface faces the respective limb 120, 130, wherein said bearing surfaces 102a, 103a face away from the first outer side 10 of the first plate heat exchanger module A. By this means, the first plate heat exchanger module A cannot be moved away from the second plate heat exchanger module B counter to the first direction of extension X, since the second and third limb 120, 130 then press via said bearing surfaces 102a, 103a against the respectively associated second and third connecting element 102, 103 and prevent the first plate heat exchanger module A from being spaced apart further from the second plate heat exchanger module B. However, owing to the distance between the first limb 110 of the first connecting element 101 and the two further connecting elements 102, 103, there is the possibility that the first plate heat exchanger module A can move relative to the second plate heat exchanger module B along the second direction of extension Y of the two further limbs 120, 130 of the first connecting element 101. Owing to said movement possibility, thermal stresses between the two plate heat exchanger modules A, B can be correspondingly relaxed or avoided from the outset.

The connecting means 100 according to the invention serves, according to FIG. 2, in particular to prevent expansion of a plate heat exchanger which consists of a first and a second plate heat exchanger module A, B which, irrespective of separate headers H′, are charged at an upper end with a process medium via at least one common header H. In the event of a temperature-induced shrinkage of the common header H, the module connection can expand at an opposite lower end of the plate heat exchanger A, B, that is to say, the two first outer sides 10, 11 move away from each other there. This can be prevented by a connecting means 100 according to the invention by the latter fixing the two first outer sides 10, 11 to each other and in said region normally to the outer sides 10, 11 and in the Z direction. Such a connecting means 100 is preferably also provided on third outer sides (not visible in FIG. 2) of the plate heat exchanger modules A, B, which outer sides run parallel to the second outer sides 20, 21.

Furthermore, dimensions for the individual connecting elements 101, 102, 103 are indicated by way of example in FIG. 1 in millimeters. In particular, a preferred radius of curvature of a rounding between the first and the second limb 110, 120 or the first and the third limb 110 and 130 is preferably 10 millimeters. However, these dimensions are not fixed and can vary depending on the mass of the components and the forces to be anticipated.

Finally, FIG. 3 shows two alternative connecting means 100, wherein the first alternative (FIG. 3 at the top) provides a second connecting element 102 which, as before, is of rectangular design two-dimensionally and is fixed to the second outer side 21 of the second plate heat exchanger module B via a weld, and therefore said connecting element partially protrudes beyond the first outer side 11 of the second plate heat exchanger module B and comes to lie with said section in front of the second outer side 20 of the first plate heat exchanger module A and bears against said outer side.

In contrast to FIGS. 1 and 2, the first connecting element 101 here is not of T-shaped design, but rather of U-shaped design. That is to say, a second limb 120 branches off from the first limb 110 of the first connecting element 101 counter to the second direction of extension Y, said second limb 120 extending behind the second connecting element 102, wherein a third limb 130 branches off in turn from an end region of the second limb 120 in the direction of the first plate heat exchanger module A such that the first connecting means 101 engages in a U-shaped manner around the second connecting means 102 in the plane of extension thereof. The first connecting element 101 bears here with the second limb 120 thereof against a bearing surface 102a of the second connecting element 102, which bearing surface faces the second limb 120, wherein said bearing surface 102a faces away from the first outer side 10 of the first plate heat exchanger module A. By this means, in turn, the first plate heat exchanger module A cannot be moved away from the second plate heat exchanger module 13 counter to the first direction of extension X since the second limb 120 of the first connecting element 101 then presses against the second connecting element 102 via said bearing surfaces 102a and prevents the first plate heat exchanger module A from being spaced apart further from the second plate heat exchanger module B. Furthermore, owing to the U shape, the first and the third limb 110, 130 of the first connecting element 101 are arranged on both sides of the second connecting element 102 spaced apart therefrom, and therefore a certain relative movement of the two plate heat exchanger modules A, B with respect to each other is possible along the second direction of extension Y. The U-shaped first connecting element 101 is welded to the second outer side 20 of the first plate heat exchanger module A via a respective end region 110a, 130a of the first and the third limb 110, 130. A relative movement of the plate heat exchanger modules A, B in the Z direction can likewise be prevented by the alternating overlapping by means of the connecting elements 101, 102. According to a third alternative embodiment (FIG. 3 at the bottom), the first and the second connecting elements 101, 102 are of L-shaped design, wherein the two connecting elements 101, 102 of the connecting means 100 engage behind each other in order to fix the two first outer sides 10, 11 to each other normally to the first outer sides 10, 11. The first connecting element 101 here has a first limb 110 which extends along the first direction of extension X and is welded to the second outer side 20 of the first plate heat exchanger module A via an end region 110a of the first limb 110. The first limb 110 protrudes here beyond the first outer side 10 of the first plate heat exchanger module A and partially bears against the second outer side 21 of the second plate heat exchanger module B. In order to form the L shape, a second limb 120 now branches off from an opposite, further end region of the first limb 110 of the first connecting element 101 (counter to the second direction of extension Y), said second limb 120 extending with a free end region 120a behind the second connecting element 102 and bearing against the second outer side 21 of the second plate heat exchanger module B. The second limb 120 of the first connecting element 101 bears here against a bearing surface 102a of the second connecting element 102, which bearing surface faces away from the first outer side 10 of the first plate heat exchanger module A and is formed on an end region 112a of a first limb 112 of the second connecting element 102, via which end region the second connecting element 102 is welded to the second outer side 21 of the second plate heat exchanger module B, wherein said first limb 112 protrudes beyond the first outer side 11 of the second plate heat exchanger module B counter to the first direction of extension X (parallel to the first limb 110 of the first connecting element 101) and partially bears here against the second outer side 20 of the first plate heat exchanger module A. A second limb 122 furthermore branches off from an end region of the first limb 112 of the second connecting element 102 along the second direction of extension Y, said second limb 122 bringing about an L shape of the second connecting element 102, wherein the second connecting element 102 now engages with said second limb 122 behind said end region 110a of the first limb 110 of the first connecting element 101. Said end region 110a likewise forms a bearing surface 101a which faces away from the first outer side 11 of the second plate heat exchanger module B and serves for the bearing of a (free) end region 122a of the second limb 122 of the second connecting element 102. If the first plate heat exchanger module A is now to be spaced apart from the second plate heat exchanger module B along the first direction of extension X, the free end region 120a of the second limb 120 of the first connecting element 101 presses against the associated bearing surface 102a of the second connecting element 102. The free end region 122a of the second limb 122 of the second connecting element 102 presses in the same manner against the associated bearing surface 101a of the first connecting element 101 such that the two plate heat exchanger modules A, B are prevented from being spaced apart, i.e. away from each other, along the first direction of extension X. Owing to an alternate overlapping of the two plate heat exchanger modules A, B by the two connecting elements 101, 102, a relative movement of the two plate heat exchanger modules A, B in the Z direction is also prevented here (see above). By the fitting of a further connecting element 100 according to the invention in the same manner on the third outer sides, which are opposite the second outer sides 20, 21, or rear sides of the plate heat exchanger modules A, B (not visible in FIGS. 1 to 3), the necessary moment of resistance of the entire plate heat exchanger in the Y-Z plane against bending about the Y and Z axis or direction is ensured.

### LIST OF REFERENCE SYMBOLS

| | |
|---|---|
| A, B | Plate heat exchanger modules |
| 2 | Fin |
| 3 | Side bars |
| 4 | Plates or cover plates |
| 10, 11 | First outer sides |
| 20, 21 | Second outer sides |
| 100 | Connecting means |
| 101 | First connecting element |
| 102 | Second connecting element |
| 103 | Third connecting element |
| 110 | First limb |
| 120 | Second limb |
| 120a, 130a, | End region |
| 110a, 112a, | |
| 120a, 122a | |
| 130 | Third limb |
| 101a, 102a, | Bearing surface |
| 103a | |
| H, H′ | Header |
| X | First, direction of extension |
| Y | Second direction of extension |

1. A plate heat exchanger, comprising:
a first and a second plate heat exchanger module which are connected to each other via a connecting means, wherein the two plate heat exchanger modules each have a first outer side, wherein the two outer sides face each other, and wherein the two plate heat exchanger modules each have a second outer side branching off from the first outer side characterized in that
the connecting means has at least one first connecting element fastened to the second outer side of the first plate heat exchanger module and a second connecting element fastened to the second outer side of the second plate heat exchanger module, wherein the first connecting element engages behind the second connecting element, and therefore the two plate heat exchanger modules are fixed on each other normally to the first outer surfaces thereof, and a lateral compensating movement between the plate heat exchanger modules is possible in order to compensate for thermal stresses.

2. The plate heat exchanger as claimed in claim 1, characterized in that the first connecting element has a first limb which, along a first direction of extension which is oriented perpendicularly to the first outer side of the first plate heat exchanger module, protrudes beyond the first outer side of the first plate heat exchanger module such that the first limb is partially arranged in front of the second outer side of the second plate heat exchanger module and bears against said outer side, and wherein the second connecting element protrudes beyond the first outer side of the second plate heat exchanger module counter to the first direction of extension such that the second connecting element is partially arranged in front of the second outer side of the first plate heat exchanger module and bears against said outer side.

3. The plate heat exchanger as claimed in claim 2, characterized in that, for the engaging behind the second connecting element, the first connecting element has a second limb which is arranged in front of the second outer side of the second plate heat exchanger module and bears against said outer side, and which branches off from the first limb along a second direction of extension oriented transversely with respect to the first direction of extension, and extends behind the second connecting element, and therefore the two plate heat exchanger modules can move relative to each other along the second direction of extension.

4. The plate heat exchanger as claimed in claim 3, characterized in that the second limb extends with a free end region of the second limb behind the second connecting element.

5. The plate heat exchanger as claimed in claim 1, characterized in that the connecting means has a third connecting element fastened to the second outer side of the second plate heat exchanger module, wherein the first connecting element also engages behind the third connecting element, and wherein the third connecting element protrudes beyond the first outer side of the second plate heat exchanger module counter to the first direction of extension such that the third connecting element is partially arranged in front of the second outer side of the first plate heat exchanger module and bears against said outer side.

6. The plate heat exchanger as claimed in claim 5, characterized in that, for the engaging behind the third connecting element, the first connecting element has a third limb which branches off from the first limb in the opposite direction to the second limb and is arranged in front of the second outer side of the second plate heat exchanger module and bears against said outer side, wherein the third limb extends with a free end region behind the third connecting element, and therefore the two plate heat exchanger modules can move relative to each other along the second direction of extension.

7. The plate heat exchanger as claimed in claim 6, characterized in that the second limb and the third limb are aligned with each other along the second direction of extension, and therefore the first connecting element is of T-shaped design.

8. The plate heat exchanger as claimed in claim 5, characterized in that the first limb is arranged between the second and the third connecting element along the second direction of extension, wherein the first limb is arranged spaced apart from the second and the third connecting element along the second direction of extension, and therefore the second and the third connecting element in each case define a stop for the first limb of the first connecting element, wherein said stops limit a movement of the two plate heat exchanger modules relative to each other along the second direction of extension.

9. The plate heat exchanger as claimed in claim 3, characterized in that the first connecting element has a third limb which branches off from an end region of the second limb such that the first connecting element engages around the second connecting element, wherein the third limb runs parallel to the first limb, and wherein the third limb protrudes beyond the first outer side of the first plate heat exchanger module along the first direction of extension such that the third limb is partially arranged in front of the second outer side of the second plate heat exchanger module and bears against said outer side, and wherein the first connecting element is fastened to the second outer side of the first plate heat exchanger module via an end region of the first limb and via an end region of the third limb.

10. The plate heat exchanger as claimed in claim 1, characterized in that the first connecting element is of L-shaped design, wherein the first connecting element is fastened to the second outer side of the first plate heat exchanger module via an end region of the first limb of the first connecting element.

11. The plate heat exchanger as claimed in claim 2, characterized in that the second connecting element has a first limb which protrudes beyond the first outer side of the second plate heat exchanger module counter to the first direction of extension such that the first limb of the second connecting element is partially arranged in front of the second outer side of the first plate heat exchanger module and bears against said outer side, and wherein the second connecting element is fastened to the second outer side of the second plate heat exchanger module via an end region of the first limb of the second connecting element.

12. The plate heat exchanger as claimed in claim 11, characterized in that, for engaging behind the first connecting element, the second connecting element has a second limb, and therefore the second connecting element is of L-shaped design, wherein said second limb of the second connecting element is arranged in front of the second outer side of the first plate heat exchanger module and bears against said outer side, and wherein said second limb of the second connecting element branches off from the first limb of the second connecting element along the second direction of extension and extends behind the first connecting element, and therefore the two plate heat exchanger modules can move relative to each other along the second direction of extension.

13. The plate heat exchanger as claimed in claim 1, characterized in that the first connecting element is fastened to the second outer side of the first plate heat exchanger module via a weld, and in that the second and/or the third connecting element are fastened to the second outer side of the second plate heat exchanger module in each case via a weld.

14. The plate heat exchanger as claimed in claim 1, characterized in that the first outer side of the first plate heat exchanger module is formed by a cover plate of the first plate heat exchanger module, and/or in that the first outer side of the second plate heat exchanger module is formed by a cover plate of the second plate heat exchanger module, and wherein the two plate heat exchanger modules are connected to each other via a common header.

15. A method for repairing or retrofitting a plate heat exchanger which has a first and a second plate heat exchanger module, wherein the two plate heat exchanger modules each have a first outer side, wherein the two outer sides face each other, or bear against each other, and wherein the two plate heat exchanger modules each have a second outer side branching off from the first outer side, characterized in that
a first connecting element of a connecting means is fitted on the second outer side of the first plate heat exchanger module and a second connecting element of the connecting means is fitted on the second outer side of the second plate heat exchanger module, wherein the first connecting element engages behind the second connecting element, and therefore the two plate heat exchanger modules are fixed on each other normally to the first outer surfaces thereof, and a lateral compensating movement between the plate heat exchanger modules is possible in order to compensate for thermal stresses.
